(19) United States
(12) Patent Application Publication
(10) Pub. No.: US 2019/0188285 A1
(43) Pub. Date: Jun. 20, 2019

(54) Image Search with Embedding-based Models on Online Social Networks

(71) Applicant: Facebook, Inc., Menlo Park, CA (US)

(72) Inventors: Cristina Scheau, Redwood City, CA (US); Shengqi Yang, Sunnyvale, CA (US); Yaming Wang, Greenbelt, MD (US)

(21) Appl. No.: 15/847,451

(22) Filed: Dec. 19, 2017

(51) Int. Cl. G06F 17/30

(52) U.S. Cl. CPC G06F 17/30256; G06N 3/08; G06F 17/30991; G06F 17/30867

(57) ABSTRACT

In one embodiment, a method includes receiving a query; generating a query embedding representing the query corresponding to a point in an n-dimensional embedding space; identifying one or more image objects matching the query; accessing, for each of the identified image objects, an image embedding representing the image object corresponding to a point in an m-dimensional embedding space; transforming, using a relevance model, the query embedding and each of the image embeddings into a joint p-dimensional embedding space; calculating, for each identified image object, a relevance-score based on a similarity metric between the transformed query embedding and the transformed image embedding; generating search results based on the calculated relevance-scores; and sending, to the client system in response to the query, instructions for presenting a search-results interface to the user, wherein the search-results interface includes search results referencing identified image objects presented in ranked order based on the respective relevance-scores.

### TECHNICAL FIELD

This disclosure generally relates to social graphs and performing searches for objects within a social-networking environment.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

Social-graph analysis views social relationships in terms of network theory consisting of nodes and edges. Nodes represent the individual actors within the networks, and edges represent the relationships between the actors. The resulting graph-based structures are often very complex. There can be many types of nodes and many types of edges for connecting nodes. In its simplest form, a social graph is a map of all of the relevant edges between all the nodes being studied.

### SUMMARY OF PARTICULAR EMBODIMENTS

In particular embodiments, the social-networking system may identify image objects responsive to a query. The social-networking system may access a query embedding representing the query and, for each identified image object, access an image embedding representing the image object. The query embedding may be generated based on one or more features associated with the query and may correspond to a point in an n-dimensional embedding space. As an example and not by way of limitation, the query embedding may be generated based on one or more n-grams of the query, a reconstructed embedding of the query, a search intent of the query, one or more head-terms and one or more modified terms of the query, one or more entities associated with the query, one or more concepts associated with the query, any other suitable information, or any suitable combination thereof. Each image embedding representing an image object may be generated based on one or more features of the image object and may correspond to a point in an m-dimensional embedding space. As an example and not by way of limitation, an image embedding representing an image object may be generated based on one or more objects depicted in the image object, one or more concepts associated with the image object, any other suitable feature of the image object, or any suitable combination thereof. The social-networking system may transform, using a relevance model, the query embedding and each of the image embeddings into a joint p-dimensional embedding space. The relevance model may be trained using a plurality of training queries and a plurality of training image objects. Each training image may be a positive or a negative training image. The relevance model may be trained by minimizing a ranking loss. The translated query embedding and the translated image embedding may be used to calculate a relevance-score for the identified image object. One technical problem for search engines is to assess a query's relevance to an image object quickly and accurately. When search results that are less relevant to the query are returned to the user, the user may have to execute further queries in an attempt to find more relevant results, burdening the search engine with additional requests, thereby consuming additional computing resources. Embodiments described herein may provide the technical advantage of providing more relevant search results quickly and at a relatively large scale. This may reduce the number of search results returned to a user, reduce the amount of content delivered to a user, and reduce the time a querying user must spend interacting with a search-results interface to find a relevant search result. Although this disclosure describes generating search results responsive to a query in a particular manner, this disclosure contemplates generating search results responsive to a query in any suitable manner. Moreover, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates an example partitioning for storing objects of a social-networking system.

FIG. 4 illustrates an example view of a vector space.

FIG. 5 illustrates an example artificial neural network.

FIG. 6 illustrates an example joint embedding.

FIG. 7 illustrates an example of training an example relevance model.

FIG. 8 illustrates an example search results interface.

FIG. 9 illustrates an example method 900 for searching for image objects.

FIG. 10 illustrates an example computer system.

### DESCRIPTION OF EXAMPLE EMBODIMENTS

### System Overview

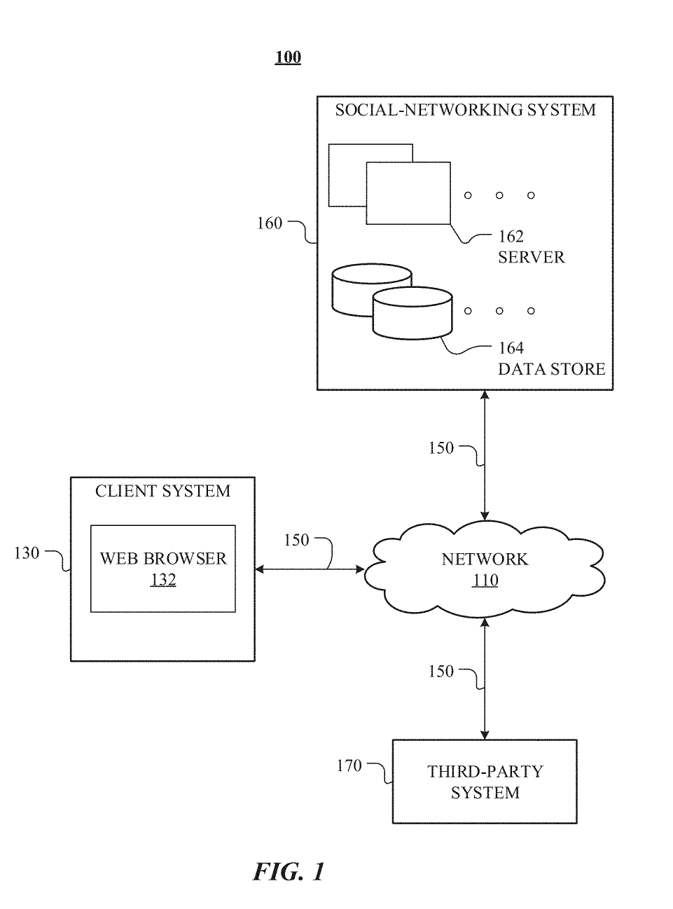

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of a client system 130, a social-networking system 160, a third-party system 170, and a network 110, this disclosure contemplates any suitable arrangement of a client system 130, a social-networking system 160, a third-party system 170, and a network 110. As an example and not by way of limitation, two or more of a client system 130, a social-networking system 160, and a third-party system 170 may be connected to each other directly, bypassing a network 110. As another example, two or more of a client system 130, a social-networking system 160, and a third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client systems 130, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 110 may include one or more networks 110.

Links 150 may connect a client system 130, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be an electronic device including hardware, software, or embedded logic components or a combination of two or more such components and capable of carrying out the appropriate functionalities implemented or supported by a client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at a client system 130 to access a network 110. A client system 130 may enable its user to communicate with other users at other client systems 130.

In particular embodiments, a client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 160 may be a network-addressable computing system that can host an online social network. The social-networking system 160 may generate, store, receive, and send social-networking data, such as, for example, user-profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132, or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a request received from a client system 130. Authorization servers may be used to enforce one or more privacy settings of the users of the social-networking system 160. A privacy setting of a user determines how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Social Graphs

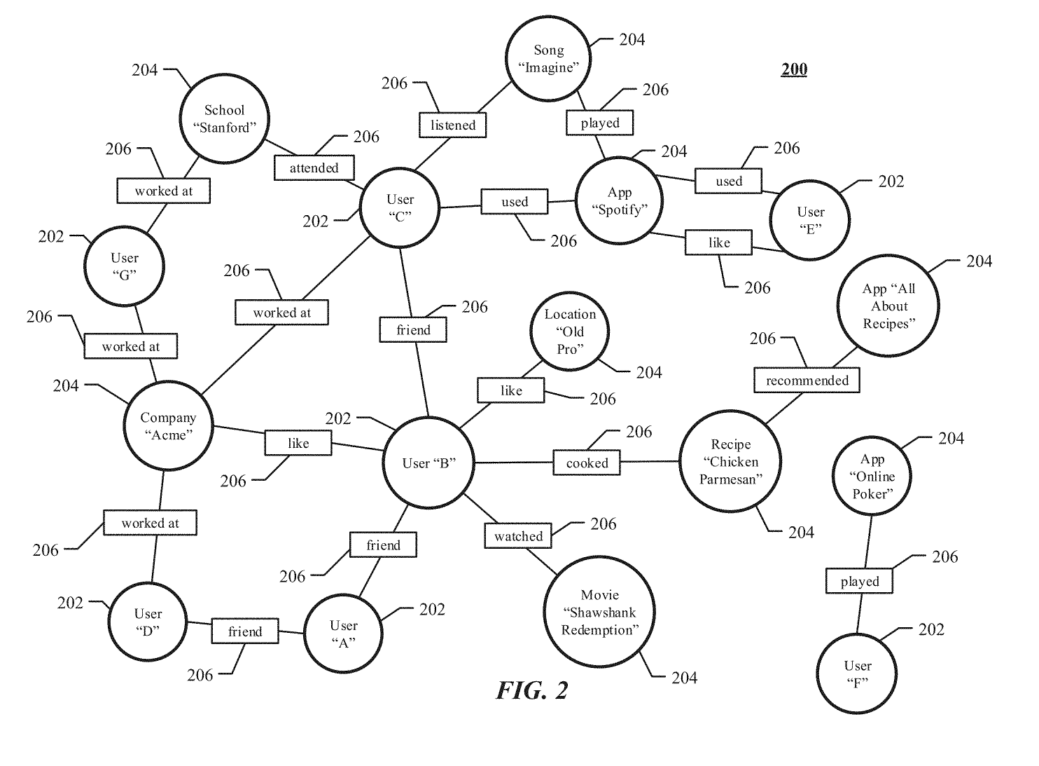

FIG. 2 illustrates an example social graph 200. In particular embodiments, the social-networking system 160 may store one or more social graphs 200 in one or more data stores. In particular embodiments, the social graph 200 may include multiple nodes—which may include multiple user nodes 202 or multiple concept nodes 204—and multiple edges 206 connecting the nodes. The example social graph 200 illustrated in FIG. 2 is shown, for didactic purposes, in a two-dimensional visual map representation. In particular embodiments, a social-networking system 160, a client system 130, or a third-party system 170 may access the social graph 200 and related social-graph information for suitable applications. The nodes and edges of the social graph 200 may be stored as data objects, for example, in a data store (such as a social-graph database). Such a data store may include one or more searchable or queryable indexes of nodes or edges of the social graph 200.

In particular embodiments, a user node 202 may correspond to a user of the social-networking system 160. As an example and not by way of limitation, a user may be an individual (human user), an entity (e.g., an enterprise, business, or third-party application), or a group (e.g., of individuals or entities) that interacts or communicates with or over the social-networking system 160. In particular embodiments, when a user registers for an account with the social-networking system 160, the social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking system 160. In particular embodiments, a user node 202 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more web interfaces.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including the social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more web interfaces.

In particular embodiments, a node in the social graph 200 may represent or be represented by a web interface (which may be referred to as a “profile interface”). Profile interfaces may be hosted by or accessible to the social-networking system 160. Profile interfaces may also be hosted on third-party websites associated with a third-party system 170. As an example and not by way of limitation, a profile interface corresponding to a particular external web interface may be the particular external web interface and the profile interface may correspond to a particular concept node 204. Profile interfaces may be viewable by all or a selected subset of other users. As an example and not by way of limitation, a user node 202 may have a corresponding user-profile interface in which the corresponding user may add content, make declarations, or otherwise express himself or herself. As another example and not by way of limitation, a concept node 204 may have a corresponding concept-profile interface in which one or more users may add content, make declarations, or express themselves, particularly in relation to the concept corresponding to concept node 204.

In particular embodiments, a concept node 204 may represent a third-party web interface or resource hosted by a third-party system 170. The third-party web interface or resource may include, among other elements, content, a selectable or other icon, or other interactable object (which may be implemented, for example, in JavaScript, AJAX, or PHP codes) representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 202 corresponding to the user and a concept node 204 corresponding to the third-party web interface or resource and store edge 206 in one or more data stores.

In particular embodiments, a pair of nodes in the social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 206 connecting the first user's user node 202 to the second user's user node 202 in the social graph 200 and store edge 206 as social-graph information in one or more of data stores 164. In the example of FIG. 2, the social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to an edge type or subtype. A concept-profile interface corresponding to a concept node 204 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, the social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, the social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, the social-networking system 160 may create an edge 206 between a user node 202 and a concept node 204 in the social graph 200. As an example and not by way of limitation, a user viewing a concept-profile interface (such as, for example, by using a web browser or a special-purpose application hosted by the user's client system 130) may indicate that he or she likes the concept represented by the concept node 204 by clicking or selecting a “Like” icon, which may cause the user's client system 130 to send to the social-networking system 160 a message indicating the user's liking of the concept associated with the concept-profile interface. In response to the message, the social-networking system 160 may create an edge 206 between user node 202 associated with the user and concept node 204, as illustrated by “like” edge 206 between the user and concept node 204. In particular embodiments, the social-networking system 160 may store an edge 206 in one or more data stores. In particular embodiments, an edge 206 may be automatically formed by the social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

### Search Queries on Online Social Networks

In particular embodiments, the social-networking system 160 may receive, from a client system of a user of an online social network, a query inputted by the user. The user may submit the query to the social-networking system 160 by, for example, selecting a query input or inputting text into query field. A user of an online social network may search for information relating to a specific subject matter (e.g., users, concepts, external content or resource) by providing a short phrase describing the subject matter, often referred to as a “search query,” to a search engine. The query may be an unstructured text query and may comprise one or more text strings (which may include one or more n-grams). In general, a user may input any character string into a query field to search for content on the social-networking system 160 that matches the text query. The social-networking system 160 may then search a data store 164 (or, in particular, a social-graph database) to identify content matching the query. The search engine may conduct a search based on the query phrase using various search algorithms and generate search results that identify resources or content (e.g., user-profile interfaces, content-profile interfaces, or external resources) that are most likely to be related to the search query. To conduct a search, a user may input or send a search query to the search engine. In response, the search engine may identify one or more resources that are likely to be related to the search query, each of which may individually be referred to as a “search result,” or collectively be referred to as the “search results” corresponding to the search query. The identified content may include, for example, social-graph elements (i.e., user nodes 202, concept nodes 204, edges 206), profile interfaces, external web interfaces, or any combination thereof. The social-networking system 160 may then generate a search-results interface with search results corresponding to the identified content and send the search-results interface to the user. The search results may be presented to the user, often in the form of a list of links on the search-results interface, each link being associated with a different interface that contains some of the identified resources or content. In particular embodiments, each link in the search results may be in the form of a Uniform Resource Locator (URL) that specifies where the corresponding interface is located and the mechanism for retrieving it. The social-networking system 160 may then send the search-results interface to the web browser 132 on the user's client system 130. The user may then click on the URL links or otherwise select the content from the search-results interface to access the content from the social-networking system 160 or from an external system (such as, for example, a third-party system 170), as appropriate. The resources may be ranked and presented to the user according to their relative degrees of relevance to the search query. The search results may also be ranked and presented to the user according to their relative degree of relevance to the user. In other words, the search results may be personalized for the querying user based on, for example, social-graph information, user information, search or browsing history of the user, or other suitable information related to the user. In particular embodiments, ranking of the resources may be determined by a ranking algorithm implemented by the search engine. As an example and not by way of limitation, resources that are more relevant to the search query or to the user may be ranked higher than the resources that are less relevant to the search query or the user. In particular embodiments, the search engine may limit its search to resources and content on the online social network. However, in particular embodiments, the search engine may also search for resources or contents on other sources, such as a third-party system 170, the internet or World Wide Web, or other suitable sources. Although this disclosure describes querying the social-networking system 160 in a particular manner, this disclosure contemplates querying the social-networking system 160 in any suitable manner.

Typeahead Processes and Queries

In particular embodiments, one or more client-side and/or backend (server-side) processes may implement and utilize a “typeahead” feature that may automatically attempt to match social-graph elements (e.g., user nodes 202, concept nodes 204, or edges 206) to information currently being entered by a user in an input form rendered in conjunction with a requested interface (such as, for example, a user-profile interface, a concept-profile interface, a search-results interface, a user interface/view state of a native application associated with the online social network, or another suitable interface of the online social network), which may be hosted by or accessible in the social-networking system 160. In particular embodiments, as a user is entering text to make a declaration, the typeahead feature may attempt to match the string of textual characters being entered in the declaration to strings of characters (e.g., names, descriptions) corresponding to users, concepts, or edges and their corresponding elements in the social graph 200. In particular embodiments, when a match is found, the typeahead feature may automatically populate the form with a reference to the social-graph element (such as, for example, the node name/type, node ID, edge name/type, edge ID, or another suitable reference or identifier) of the existing social-graph element. In particular embodiments, as the user enters characters into a form box, the typeahead process may read the string of entered textual characters. As each keystroke is made, the frontend-typeahead process may send the entered character string as a request (or call) to the backend-typeahead process executing within the social-networking system 160. In particular embodiments, the typeahead process may use one or more matching algorithms to attempt to identify matching social-graph elements. In particular embodiments, when a match or matches are found, the typeahead process may send a response to the user's client system 130 that may include, for example, the names (name strings) or descriptions of the matching social-graph elements as well as, potentially, other metadata associated with the matching social-graph elements. As an example and not by way of limitation, if a user enters the characters “pok” into a query field, the typeahead process may display a drop-down menu that displays names of matching existing profile interfaces and respective user nodes 202 or concept nodes 204, such as a profile interface named or devoted to “poker” or “pokemon,” which the user can then click on or otherwise select thereby confirming the desire to declare the matched user or concept name corresponding to the selected node.

More information on typeahead processes may be found in U.S. patent application Ser. No. 12/763,162, filed 19 Apr. 2010, and U.S. patent application Ser. No. 13/556,072, filed 23 Jul. 2012, which are incorporated by reference.

In particular embodiments, the typeahead processes described herein may be applied to search queries entered by a user. As an example and not by way of limitation, as a user enters text characters into a query field, a typeahead process may attempt to identify one or more user nodes 202, concept nodes 204, or edges 206 that match the string of characters entered into the query field as the user is entering the characters. As the typeahead process receives requests or calls including a string or n-gram from the text query, the typeahead process may perform or cause to be performed a search to identify existing social-graph elements (i.e., user nodes 202, concept nodes 204, edges 206) having respective names, types, categories, or other identifiers matching the entered text. The typeahead process may use one or more matching algorithms to attempt to identify matching nodes or edges. When a match or matches are found, the typeahead process may send a response to the user's client system 130 that may include, for example, the names (name strings) of the matching nodes as well as, potentially, other metadata associated with the matching nodes. The typeahead process may then display a drop-down menu that displays names of matching existing profile interfaces and respective user nodes 202 or concept nodes 204, and displays names of matching edges 206 that may connect to the matching user nodes 202 or concept nodes 204, which the user can then click on or otherwise select thereby confirming the desire to search for the matched user or concept name corresponding to the selected node, or to search for users or concepts connected to the matched users or concepts by the matching edges. Alternatively, the typeahead process may simply auto-populate the form with the name or other identifier of the top-ranked match rather than display a drop-down menu. The user may then confirm the auto-populated declaration simply by keying “enter” on a keyboard or by clicking on the auto-populated declaration. Upon user confirmation of the matching nodes and edges, the typeahead process may send a request that informs the social-networking system 160 of the user's confirmation of a query containing the matching social-graph elements. In response to the request sent, the social-networking system 160 may automatically (or alternately based on an instruction in the request) call or otherwise search a social-graph database for the matching social-graph elements, or for social-graph elements connected to the matching social-graph elements as appropriate. Although this disclosure describes applying the typeahead processes to search queries in a particular manner, this disclosure contemplates applying the typeahead processes to search queries in any suitable manner.

In connection with search queries and search results, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, and U.S. patent application Ser. No. 12/978,265, filed 23 Dec. 2010, which are incorporated by reference.

Structured Search Queries

In particular embodiments, in response to a text query received from a first user (i.e., the querying user), the social-networking system 160 may parse the text query and identify portions of the text query that correspond to particular social-graph elements. However, in some cases a query may include one or more terms that are ambiguous, where an ambiguous term is a term that may possibly correspond to multiple social-graph elements. To parse the ambiguous term, the social-networking system 160 may access a social graph 200 and then parse the text query to identify the social-graph elements that corresponded to ambiguous n-grams from the text query. The social-networking system 160 may then generate a set of structured queries, where each structured query corresponds to one of the possible matching social-graph elements. These structured queries may be based on strings generated by a grammar model, such that they are rendered in a natural-language syntax with references to the relevant social-graph elements. As an example and not by way of limitation, in response to the text query, “show me friends of my girlfriend,” the social-networking system 160 may generate a structured query “Friends of Stephanie,” where “Friends” and “Stephanie” in the structured query are references corresponding to particular social-graph elements. The reference to “Stephanie” would correspond to a particular user node 202 (where the social-networking system 160 has parsed the n-gram “my girlfriend” to correspond with a user node 202 for the user “Stephanie”), while the reference to “Friends” would correspond to friend-type edges 206 connecting that user node 202 to other user nodes 202 (i.e., edges 206 connecting to “Stephanie's” first-degree friends). When executing this structured query, the social-networking system 160 may identify one or more user nodes 202 connected by friend-type edges 206 to the user node 202 corresponding to “Stephanie”. As another example and not by way of limitation, in response to the text query, “friends who work at facebook,” the social-networking system 160 may generate a structured query “My friends who work at Facebook,” where “my friends,” “work at,” and “Facebook” in the structured query are references corresponding to particular social-graph elements as described previously (i.e., a friend-type edge 206, a work-at-type edge 206, and concept node 204 corresponding to the company “Facebook”). By providing suggested structured queries in response to a user's text query, the social-networking system 160 may provide a powerful way for users of the online social network to search for elements represented in the social graph 200 based on their social-graph attributes and their relation to various social-graph elements. Structured queries may allow a querying user to search for content that is connected to particular users or concepts in the social graph 200 by particular edge-types. The structured queries may be sent to the first user and displayed in a drop-down menu (via, for example, a client-side typeahead process), where the first user can then select an appropriate query to search for the desired content. Some of the advantages of using the structured queries described herein include finding users of the online social network based upon limited information, bringing together virtual indexes of content from the online social network based on the relation of that content to various social-graph elements, or finding content related to you and/or your friends. Although this disclosure describes generating particular structured queries in a particular manner, this disclosure contemplates generating any suitable structured queries in any suitable manner.

More information on element detection and parsing queries may be found in U.S. patent application Ser. No. 13/556,072, filed 23 Jul. 2012, U.S. patent application Ser. No. 13/731,866, filed 31 Dec. 2012, and U.S. patent application Ser. No. 13/732,101, filed 31 Dec. 2012, each of which is incorporated by reference. More information on structured search queries and grammar models may be found in U.S. patent application Ser. No. 13/556,072, filed 23 Jul. 2012, U.S. patent application Ser. No. 13/674,695, filed 12 Nov. 2012, and U.S. patent application Ser. No. 13/731,866, filed 31 Dec. 2012, each of which is incorporated by reference.

Generating Keywords and Keyword Queries

In particular embodiments, the social-networking system 160 may provide customized keyword completion suggestions to a querying user as the user is inputting a text string into a query field. Keyword completion suggestions may be provided to the user in a non-structured format. In order to generate a keyword completion suggestion, the social-networking system 160 may access multiple sources within the social-networking system 160 to generate keyword completion suggestions, score the keyword completion suggestions from the multiple sources, and then return the keyword completion suggestions to the user. As an example and not by way of limitation, if a user types the query “friends stan,” then the social-networking system 160 may suggest, for example, “friends stanford,” “friends stanford university,” “friends stanley,” “friends stanley cooper,” “friends stanley kubrick,” “friends stanley cup,” and “friends stanlonski.” In this example, the social-networking system 160 is suggesting the keywords which are modifications of the ambiguous n-gram “stan,” where the suggestions may be generated from a variety of keyword generators. The social-networking system 160 may have selected the keyword completion suggestions because the user is connected in some way to the suggestions. As an example and not by way of limitation, the querying user may be connected within the social graph 200 to the concept node 204 corresponding to Stanford University, for example by like- or attended-type edges 206. The querying user may also have a friend named Stanley Cooper. Although this disclosure describes generating keyword completion suggestions in a particular manner, this disclosure contemplates generating keyword completion suggestions in any suitable manner.

More information on keyword queries may be found in U.S. patent application Ser. No. 14/244,748, filed 3 Apr. 2014, U.S. patent application Ser. No. 14/470,607, filed 27 Aug. 2014, and U.S. patent application Ser. No. 14/561,418, filed 5 Dec. 2014, each of which is incorporated by reference.

### Indexing Based on Object-Type

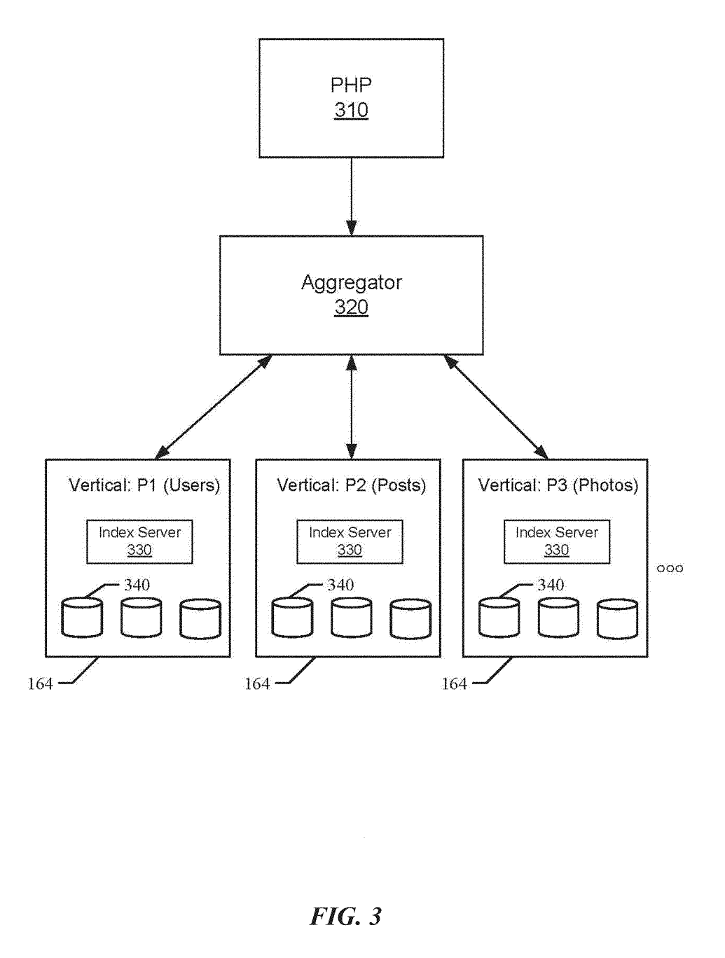

FIG. 3 illustrates an example partitioning for storing objects of a social-networking system 160. A plurality of data stores 164 (which may also be called “verticals”) may store objects of social-networking system 160. The amount of data (e.g., data for a social graph 200) stored in the data stores may be very large. As an example and not by way of limitation, a social graph used by Facebook, Inc. of Menlo Park, Calif. can have a number of nodes in the order of 10⁸, and a number of edges in the order of 10¹⁰. Typically, a large collection of data such as a large database may be divided into a number of partitions. As the index for each partition of a database is smaller than the index for the overall database, the partitioning may improve performance in accessing the database. As the partitions may be distributed over a large number of servers, the partitioning may also improve performance and reliability in accessing the database. Ordinarily, a database may be partitioned by storing rows (or columns) of the database separately. In particular embodiments, a database maybe partitioned based on object-types. Data objects may be stored in a plurality of partitions, each partition holding data objects of a single object-type. In particular embodiments, social-networking system 160 may retrieve search results in response to a search query by submitting the search query to a particular partition storing objects of the same object-type as the search query's expected results. Although this disclosure describes storing objects in a particular manner, this disclosure contemplates storing objects in any suitable manner.

In particular embodiments, each object may correspond to a particular node of a social graph 200. An edge 206 connecting the particular node and another node may indicate a relationship between objects corresponding to these nodes. In addition to storing objects, a particular data store may also store social-graph information relating to the object. Alternatively, social-graph information about particular objects may be stored in a different data store from the objects. Social-networking system 160 may update the search index of the data store based on newly received objects, and relationships associated with the received objects.

In particular embodiments, each data store 164 may be configured to store objects of a particular one of a plurality of object-types in respective data storage devices 340. An object-type may be, for example, a user, a photo, a post, a comment, a message, an event listing, a web interface, an application, a location, a user-profile interface, a concept-profile interface, a user group, an audio file, a video, an offer/coupon, or another suitable type of object. Although this disclosure describes particular types of objects, this disclosure contemplates any suitable types of objects. As an example and not by way of limitation, a user vertical P1 illustrated in FIG. 3 may store user objects. Each user object stored in the user vertical P1 may comprise an identifier (e.g., a character string), a user name, and a profile picture for a user of the online social network. Social-networking system 160 may also store in the user vertical P1 information associated with a user object such as language, location, education, contact information, interests, relationship status, a list of friends/contacts, a list of family members, privacy settings, and so on. As an example and not by way of limitation, a post vertical P2 illustrated in FIG. 3 may store post objects. Each post object stored in the post vertical P2 may comprise an identifier, a text string for a post posted to social-networking system 160. Social-networking system 160 may also store in the post vertical P2 information associated with a post object such as a time stamp, an author, privacy settings, users who like the post, a count of likes, comments, a count of comments, location, and so on. As an example and not by way of limitation, a photo vertical P3 may store photo objects (or objects of other media types such as video or audio). Each photo object stored in the photo vertical P3 may comprise an identifier and a photo. Social-networking system 160 may also store in the photo vertical P3 information associated with a photo object such as a time stamp, an author, privacy settings, users who are tagged in the photo, users who like the photo, comments, and so on. In particular embodiments, each data store may also be configured to store information associated with each stored object in data storage devices 340.

In particular embodiments, objects stored in each vertical 164 may be indexed by one or more search indices. The search indices may be hosted by respective index server 330 comprising one or more computing devices (e.g., servers). The index server 330 may update the search indices based on data (e.g., a photo and information associated with a photo) submitted to social-networking system 160 by users or other processes of social-networking system 160 (or a third-party system). The index server 330 may also update the search indices periodically (e.g., every 24 hours). The index server 330 may receive a query comprising a search term, and access and retrieve search results from one or more search indices corresponding to the search term. In some embodiments, a vertical corresponding to a particular object-type may comprise a plurality of physical or logical partitions, each comprising respective search indices.

In particular embodiments, social-networking system 160 may receive a search query from a PHP (Hypertext Preprocessor) process 310. The PHP process 310 may comprise one or more computing processes hosted by one or more servers 162 of social-networking system 160. The search query may be a text string or a search query submitted to the PHP process by a user or another process of social-networking system 160 (or third-party system 170). In particular embodiments, an aggregator 320 may be configured to receive the search query from PHP process 310 and distribute the search query to each vertical. The aggregator may comprise one or more computing processes (or programs) hosted by one or more computing devices (e.g. servers) of the social-networking system 160. Particular embodiments may maintain the plurality of verticals 164 as illustrated in FIG. 3. Each of the verticals 164 may be configured to store a single type of object indexed by a search index as described earlier. In particular embodiments, the aggregator 320 may receive a search request. For example, the aggregator 320 may receive a search request from a PHP (Hypertext Preprocessor) process 210 illustrated in FIG. 2. In particular embodiments, the search request may comprise a text string. The search request may be a structured or substantially unstructured text string submitted by a user via a PHP process. The search request may also be structured or a substantially unstructured text string received from another process of the social-networking system. In particular embodiments, the aggregator 320 may determine one or more search queries based on the received search request. In particular embodiments, each of the search queries may have a single object type for its expected results (i.e., a single result-type). In particular embodiments, the aggregator 320 may, for each of the search queries, access and retrieve search query results from at least one of the verticals 164, wherein the at least one vertical 164 is configured to store objects of the object type of the search query (i.e., the result-type of the search query). In particular embodiments, the aggregator 320 may aggregate search query results of the respective search queries. For example, the aggregator 320 may submit a search query to a particular vertical and access index server 330 of the vertical, causing index server 330 to return results for the search query.

More information on indexes and search queries may be found in U.S. patent application Ser. No. 13/560,212, filed 27 Jul. 2012, U.S. patent application Ser. No. 13/560,901, filed 27 Jul. 2012, U.S. patent application Ser. No. 13/723,861, filed 21 Dec. 2012, and U.S. patent application Ser. No. 13/870,113, filed 25 Apr. 2013, each of which is incorporated by reference.

### Vector Spaces and Embeddings

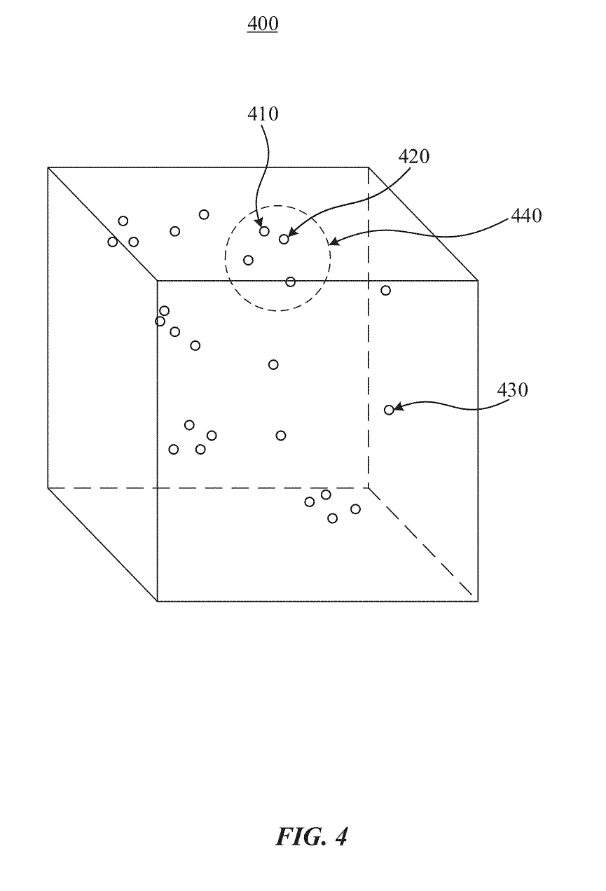

FIG. 4 illustrates an example view of a vector space 400. The vector space 400 may also be referred to as a feature space or an embedding space. In particular embodiments, an object or an n-gram may be represented in a d-dimensional vector space, where d denotes any suitable number of dimensions. Although the vector space 400 is illustrated as a three-dimensional space, this is for illustrative purposes only, as the vector space 400 may be of any suitable dimension. Each vector may comprise coordinates corresponding to a particular point in the vector space 400 (i.e., the terminal point of the vector). As an example and not by way of limitation, vectors 410, 420, and 430 may be represented as points in the vector space 400, as illustrated in FIG. 4. In particular embodiments, a mapping from data to a vector may be relatively insensitive to small changes in the data (e.g., a small change in the data being mapped to a vector will still result in approximately the same mapped vector). In particular embodiments, the social-networking system 160 may map objects of different modalities to the same vector space or use a function jointly trained to map one or more modalities to a feature vector (e.g., between visual, audio, text). Although this disclosure may describe a particular vector space, this disclosure contemplates any suitable vector space.

In particular embodiments, an n-gram may be mapped to a respective vector representation, which may be referred to as a term vector. As an example and not by way of limitation, n-grams t₁ and t₂ may be mapped to vectors [symbol] and [symbol] in the vector space 400, respectively, by applying a function [symbol] defined by a dictionary, such that [symbol] = [symbol] (t₁) and [symbol] = [symbol] (t₂). As another example and not by way of limitation, a dictionary trained to map text to a vector representation may be utilized, or such a dictionary may be itself generated via training. As another example and not by way of limitation, a model, such as Word2vec, may be used to map an n-gram to a vector representation in the vector space 400. In particular embodiments, an n-gram may be mapped to a vector representation in the vector space 400 by using a machine leaning model (e.g., a neural network). The machine learning model may have been trained using training data (e.g., a corpus of objects each comprising n-grams). In particular embodiments, the machine learning model may be trained using an objective function or a loss function (e.g., a function that is to be maximized or minimized over training data). As an example and not by way of limitation, a machine learning model may be trained to predict an n-gram in a sentence given other n-grams in the sentence (e.g., a continuous bag-of-words model). As another example and not by way of limitation, a machine learning model may be trained to predict other n-grams in a sentence given an n-gram in the sentence (e.g., a skip-gram model). Although this disclosure describes representing an n-gram in a vector space in a particular manner, this disclosure contemplates representing an n-gram in a vector space in any suitable manner.

In particular embodiments, an object may be represented in the vector space 400 as a vector, which may be referred to as a feature vector or an object embedding. As an example and not by way of limitation, objects e₁ and e₂ may be mapped to vectors [symbol] and [symbol] in the vector space 400, respectively, by applying a function [symbol] such that [symbol] = [symbol] (e₁) and [symbol] = [symbol] (e₂). In particular embodiments, an object may be mapped to a vector based on one or more properties, attributes, or features of the object, relationships of the object with other objects, or any other suitable information associated with the object. As an example and not by way of limitation, a function [symbol] may map objects to vectors by feature extraction, which may start from an initial set of measured data and build derived values (e.g., features). As an example and not by way of limitation, an object comprising a video or an image may be mapped to a vector by using an algorithm to detect or isolate various desired portions or shapes of the object. Features used to calculate the vector may be based on information obtained from edge detection, corner detection, blob detection, ridge detection, scale-invariant feature transformation, edge direction, changing intensity, autocorrelation, motion detection, optical flow, thresholding, blob extraction, template matching, Hough transformation (e.g., lines, circles, ellipses, arbitrary shapes), or any other suitable information. As another example and not by way of limitation, an object comprising audio data may be mapped to a vector based on features such as a spectral slope, a tonality coefficient, an audio spectrum centroid, an audio spectrum envelope, a Mel-frequency cepstrum, or any other suitable information. In particular embodiments, when an object has data that is either too large to be efficiently processed or comprises redundant data, a function [symbol] may map the object to a vector using a transformed reduced set of features (e.g., feature selection). In particular embodiments, a function [symbol] may map an object e to a vector [symbol] (e) based on one or more n-grams associated with object e. In particular embodiments, an object may be mapped to a vector by using a machine learning model. In particular embodiments, the machine learning model may be trained using an objective function or a loss function. Although this disclosure describes representing an object in a vector space in a particular manner, this disclosure contemplates representing an object in a vector space in any suitable manner.

In particular embodiments, the social-networking system 160 may calculate a similarity metric of vectors in the vector space 400. A similarity metric may be a cosine similarity, a Minkowski distance, a Mahalanobis distance, a Jaccard similarity coefficient, or any suitable similarity metric. As an example and not by way of limitation, a similarity metric of [symbol] and [symbol] may be a cosine similarity

$$\frac{\vec{{v}_{1}} \cdot \vec{{v}_{2}}}{‖ \vec{{v}_{1}} ‖ ‖ \vec{{v}_{2}} ‖} .$$

As another example and not by way of limitation, a similarity metric of [symbol] and [symbol] may be a Euclidean distance ∥ [symbol] − [symbol] ∥. A similarity metric of two vectors may represent how similar the two objects or n-grams corresponding to the two vectors, respectively, are to one another, as measured by the distance between the two vectors in the vector space 400. As an example and not by way of limitation, vector 410 and vector 420 may correspond to objects that are more similar to one another than the objects corresponding to vector 410 and vector 430, based on the distance between the respective vectors. In particular embodiments, the social-networking system 160 may determine a cluster of vector space 400. A cluster may be a set of one or more points corresponding to feature vectors of objects or n-grams in the vector space 400, and the objects or n-grams whose feature vectors are in the cluster may belong to the same class or have a relationship to one another (e.g., a semantic relationship, a visual relationship, a topical relationship, etc.). As an example and not by way of limitation, cluster 440 may correspond to sports-related content and another cluster may correspond to food-related content. Although this disclosure describes calculating a similarity metric between vectors and determining a cluster in a particular manner, this disclosure contemplates calculating a similarity metric between vectors or determining a cluster in any suitable manner.

More information on vector spaces, embeddings, feature vectors, and similarity metrics may be found in U.S. patent application Ser. No. 14/949,436, filed 23 Nov. 2015, U.S. patent application Ser. No. 15/286,315, filed 5 Oct. 2016, and U.S. patent application Ser. No. 15/365,789, filed 30 Nov. 2016, each of which is incorporated by reference.

### Artificial Neural Networks

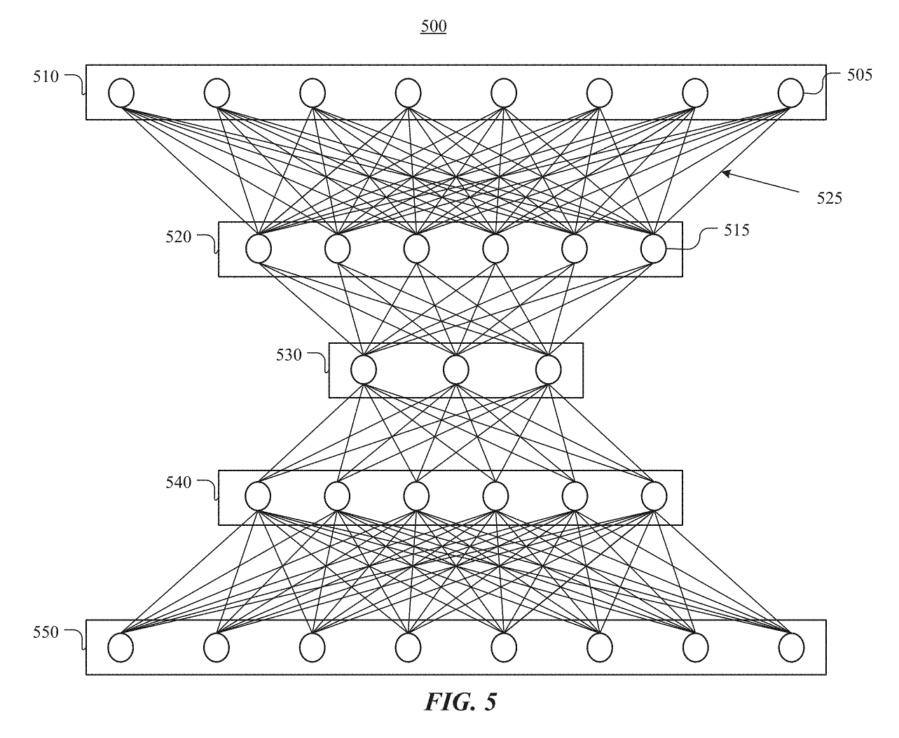

FIG. 5 illustrates an example artificial neural network (“ANN”) 500. In particular embodiments, an ANN may refer to a computational model comprising one or more nodes. Example ANN 500 may comprise an input layer 510, hidden layers 520, 530, 540, and an output layer 550. Each layer of the ANN 500 may comprise one or more nodes, such as a node 505 or a node 515. In particular embodiments, each node of an ANN may be connected to another node of the ANN. As an example and not by way of limitation, each node of the input layer 510 may be connected to one of more nodes of the hidden layer 520. In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 5 depicts a particular ANN with a particular number of layers, a particular number of nodes, and particular connections between nodes, this disclosure contemplates any suitable ANN with any suitable number of layers, any suitable number of nodes, and any suitable connections between nodes. As an example and not by way of limitation, although FIG. 5 depicts a connection between each node of the input layer 510 and each node of the hidden layer 520, one or more nodes of the input layer 510 may not be connected to one or more nodes of the hidden layer 520.

In particular embodiments, an ANN may be a feedforward ANN (e.g., an ANN with no cycles or loops where communication between nodes flows in one direction beginning with the input layer and proceeding to successive layers). As an example and not by way of limitation, the input to each node of the hidden layer 520 may comprise the output of one or more nodes of the input layer 510. As another example and not by way of limitation, the input to each node of the output layer 550 may comprise the output of one or more nodes of the hidden layer 540. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example and not by way of limitation, the input into residual block N may be F(x)+x, where F(x) may be the output of residual block N−1, x may be the input into residual block N−1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example and not by way of limitation, an activation function may be an identity function, a binary step function, a logistic function, or any other suitable function. As another example and not by way of limitation, an activation function for a node k may be the sigmoid function

$${F}_{k} ( {s}_{k} ) = \frac{1}{1 + {e}^{- {s}_{k}}} ,$$

the hyperbolic tangent function

$${F}_{k} ( {s}_{k} ) = \frac{{e}^{{s}_{k}} - {e}^{- {s}_{k}}}{{e}^{{s}_{k}} + {e}^{- {s}_{k}}} ,$$

the rectifier Fₖ(sₖ)=max(0, sₖ), or any other suitable function Fₖ(sₖ), where sₖ may be the effective input to node k. In particular embodiments, the input of an activation function corresponding to a node may be weighted. Each node may generate output using a corresponding activation function based on weighted inputs. In particular embodiments, each connection between nodes may be associated with a weight. As an example and not by way of limitation, a connection 525 between the node 505 and the node 515 may have a weighting coefficient of 0.4, which may indicate that 0.4 multiplied by the output of the node 505 is used as an input to the node 515. As another example and not by way of limitation, the output yₖ of node k may be yₖ=Fₖ(sₖ), where Fₖ may be the activation function corresponding to node k, sₖ=Σⱼ(wⱼₖxⱼ) may be the effective input to node k, xⱼ may be the output of a node j connected to node k, and wⱼₖ may be the weighting coefficient between node j and node k. In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, an ANN may be trained using training data. As an example and not by way of limitation, training data may comprise inputs to the ANN 500 and an expected output. As another example and not by way of limitation, training data may comprise vectors each representing a training object and an expected label for each training object. In particular embodiments, training an ANN may comprise modifying the weights associated with the connections between nodes of the ANN by optimizing an objective function. As an example and not by way of limitation, a training method may be used (e.g., the conjugate gradient method, the gradient descent method, the stochastic gradient descent) to backpropagate the sum-of-squares error measured as a distances between each vector representing a training object (e.g., using a cost function that minimizes the sum-of-squares error). In particular embodiments, an ANN may be trained using a dropout technique. As an example and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training an ANN in a particular manner, this disclosure contemplates training an ANN in any suitable manner.

Image Search with Embedding-Based Models

In particular embodiments, the social-networking system 160 may identify image objects responsive to a query. The social-networking system 160 may access a query embedding representing the query and, for each identified image object, access an image embedding representing the image object. The query embedding may be generated based on one or more features associated with the query and may correspond to a point in an n-dimensional embedding space. As an example and not by way of limitation, the query embedding may be generated based on one or more n-grams of the query, a reconstructed embedding of the query, a search intent of the query, one or more head-terms and one or more modified terms of the query, one or more entities associated with the query, one or more concepts associated with the query, any other suitable information, or any suitable combination thereof. Each image embedding representing an image object may be generated based on one or more features of the image object and may correspond to a point in an m-dimensional embedding space. As an example and not by way of limitation, an image embedding representing an image object may be generated based on one or more objects depicted in the image object, one or more concepts associated with the image object, any other suitable feature of the image object, or any suitable combination thereof. The social-networking system 160 may transform, using a relevance model, the query embedding and each of the image embeddings into a joint p-dimensional embedding space. The relevance model may be trained using a plurality of training queries and a plurality of training image objects. Each training image may be a positive or a negative training image. The relevance model may be trained by minimizing a ranking loss. The translated query embedding and the translated image embedding may be used to calculate a relevance-score for the identified image object. One technical problem for search engines is to assess a query's relevance to an image object quickly and accurately. When search results that are less relevant to the query are returned to the user, the user may have to execute further queries in an attempt to find more relevant results, burdening the search engine with additional requests, thereby consuming additional computing resources. Embodiments described herein may provide the technical advantage of providing more relevant search results quickly and at a relatively large scale. This may reduce the number of search results returned to a user, reduce the amount of content delivered to a user, and reduce the time a querying user must spend interacting with a search-results interface to find a relevant search result. Although this disclosure describes generating search results responsive to a query in a particular manner, this disclosure contemplates generating search results responsive to a query in any suitable manner. Moreover, although this disclosure describes or illustrates particular embodiments as providing particular advantages, particular embodiments may provide none, some, or all of these advantages.

In particular embodiments, the social-networking system 160 may receive, from a client system of a user, a query inputted by the user. The query may comprise one or more n-grams. As an example and not by way of limitation, the social-networking system 160 may receive the query “baseball”, the query “christmas decorations”, the query “santa claus pictures”, or any other suitable query. Although this disclosure describes receiving a query in a particular manner, this disclosure contemplates receiving a query in any suitable manner.

In particular embodiments, the social-networking system 160 may generate a reconstructed embedding of the query generated based on one or more term embeddings associated with the one or more n-grams of the query, respectively. A reconstructed embedding of the query may be based on one or more embeddings of the n-grams of the query. A function [symbol] may map a query to a reconstructed embedding of the query in an embedding space. As an example and not by way of limitation, for a query q comprising n-grams t₁ through tₙ, [symbol] (q) may be a pooling of the term embeddings for t₁ through tₙ. In particular embodiments, the pooling may comprise one or more of a sum pooling, an average pooling, a weighted pooling, a pooling with temporal decay, a maximum pooling, or any other suitable pooling. As an example and not by way of limitation, the pooling may be a sum pooling, such that [symbol] (q)=Σᵢ₌₁ⁿ [symbol] (tᵢ), where the function [symbol] may map an n-gram to an embedding of the n-gram. In connection with reconstructed embeddings, particular embodiments may utilize one or more systems, components, elements, functions, methods, operations, or steps disclosed in U.S. patent application Ser. No. 15/286,315, filed 5 Oct. 2016, which is incorporated by reference. Although this disclosure describes generating reconstructed embedding of a query in a particular manner, this disclosure contemplates generating reconstructed embedding of a query in any suitable manner.

In particular embodiments, the social-networking system 160 may determine a search intent of the query. A search intent may refer to the intent of the user with respect to the type of query or the type of search mode that the user is in. In response to a receiving the query, the social-networking system 160 may determine one or more search intents for the query. The search intent may be determined based on social-graph elements referenced in the query, one or more n-grams of the query, user information associated with the user, a search history of the user, pattern detection, any other suitable information related to the query or the user, or any combination thereof. As an example and not by way of limitation, if the user searches for “single women in palo alto,” and the user is a single male, the social-networking system 160 may determine that the querying user's search intent is dating-related, and return photos that match that search intent (e.g., profile pictures that portray only one person rather than group shots). In connection with search queries and search intents, particular embodiments may utilize one or more systems, components, elements, functions, methods, operations, or steps disclosed in U.S. patent application Ser. No. 13/887,015, filed 3 May 2013, and U.S. patent application Ser. No. 15/295,696, filed 17 Oct. 2016, which are incorporated by reference. Although this disclosure describes determining a search intent in a particular manner, this disclosure contemplates determining a search intent in any suitable manner.

In particular embodiments, the social-networking system 160 may parse the query to determine one or more head-terms and one or more modifier-terms of the query. A head-term may refer to an n-gram that determines a syntactic type of a phrase or the semantic category of a compound. The other n-grams of a phrase or compound may be modifier-terms. As an example and not by way of limitation, in the expression “large blue car”, the n-gram “car” may be a head-term and the n-grams “large” and “blue” may be modifier-terms. In particular embodiments, the head-terms and modifier-terms of a query may be determined based on a syntactic model. In connection with search queries and syntactic parsing, particular embodiments may utilize one or more systems, components, elements, functions, methods, operations, or steps disclosed in U.S. patent application Ser. No. 15/365,797, filed 30 Nov. 2016, which is incorporated by reference. Although this disclosure describes parsing a query in a particular manner, this disclosure contemplates parsing a query in any suitable manner.

In particular embodiments, the social-networking system 160 may parse the query to determine one or more entities associated with the query. As an example and not by way of limitation, the social-networking system 160 may parse the query to identify one or more n-grams of the query. The social-networking system 160 may identify one or more entities matching one or more of the identified n-grams. As an example and not by way of limitation, the social-networking system 160 may parse the query “new york city bus” to identify the n-grams “new york city” and “bus”. In particular embodiments, each entity may be of a particular entity type. Entity types may include social-graph entities and keywords. Social-graph entities may be users of the online social network, businesses, celebrity pages, content pages, and the like. As an example and not by way of limitation, the n-gram “new york city” may correspond to the entity New York City, the most populous city in the United States. New York City may correspond to a social-graph entity (e.g., New York City may have an official profile page on the online social network). Keywords may be n-grams that are not associated with entities on the online social network, but may still be considered a type of entity. As an example and not by way of limitation, the n-gram “bus” may be a keyword that refers to a mode of transportation. In particular embodiments, the social-networking system 160 may use a third-party website or source, such as WIKIPEDIA, to identify entity candidates. In connection with determining entities associated with a query, particular embodiments may utilize one or more systems, components, elements, functions, methods, operations, or steps disclosed in U.S. patent application Ser. No. 15/355,500, filed 18 Nov. 2016, which is incorporated by reference. Although this disclosure describes parsing a query and determining an entity associated with a query in a particular manner, this disclosure contemplates parsing a query and determining an entity associated with a query in any suitable manner.

In particular embodiments, the social-networking system 160 may identify one or more concepts associated with the query. As an example and not by way of limitation, the social-networking system 160 may determine that one or more n-grams of the query are related to a concept node. As another example and not by way of limitation, the social-networking system 160 may identify a concept associated with the query by determining that an n-gram of the query is related to a concept based on a similarity metric between an embedding representing the n-gram and an embedding representing the concept. Additionally or alternatively, the social-networking system 160 may identify a concept associated with the query based on determining that an embedding representing an n-gram of the query is in a cluster associated with the concept. As an example and not by way of limitation, for the query “baseball”, the social-networking system 160 may access an embedding of the n-gram “baseball.” The embedding space may be clustered into clusters associated with concepts, and the social-networking system 160 may determine that “baseball” is associated with the concept “sports” based on determining that the embedding of “baseball” is located in a cluster associated with the concept “sports”. As another example and not by way of limitation, for the query “santa claus pictures”, the social-networking system 160 may identify the associated concept of “Christmas” based on a similarity metric between an embedding of the n-gram “santa claus” and an embedding of the n-gram “Christmas.” Although this disclosure describes identifying a concept associated with a query in a particular manner, this disclosure contemplates identifying a concept associated with a query in any suitable manner.

In particular embodiments, the social-networking system 160 may generate a query embedding representing the query. The query embedding may correspond to a point in an n-dimensional embedding space. In particular embodiments, the query embedding representing the query may be generated based on one or more n-grams of the query, a reconstructed embedding of the query, a search intent of the query, one or more head-terms and one or more modified terms of the query, one or more entities associated with the query, one or more concepts associated with the query, any other suitable information, or any suitable combination thereof. As an example and not by way of limitation, a query embedding may be generated based on the n-grams of a query by a machine learning model. As another example and not by way of limitation, a concept associated with the query and a reconstructed embedding of the query may be input into a machine-learning model to generate a query embedding representing the query. In particular embodiments, the social-networking system 160 may generate the query embedding representing the query in real-time and responsive to receiving the query from the client system 130 of the user. Although this disclosure describes generating a query embedding in a particular manner, this disclosure contemplates query embedding in any suitable manner.

In particular embodiments, the social-networking system 160 may identify one or more image objects matching at least a portion of the query. As an example and not by way of limitation, the social-networking system 160 may identify one or more image objects associated with one or more n-grams matching one or more n-grams of the query. In particular embodiments, identifying one or more image objects matching at least a portion of the query may comprise identifying one or more image objects associated with a concept matching a concept of the query. A concept associated with an image objects may be a scene, a physical object, an animal, a plant, a place, an article of clothing, a location, or any other suitable concept. Image objects may be associated with tags that identify one or more concepts associated with the image object. As an example and not by way of limitation, an image object depicting a cat may be associated with the tag “animal” and the tag “cat” indicating that the image object is associated with the concepts animal and cat. In particular embodiments, identifying one or more image objects matching at least a portion of the query may comprise identifying one or more image objects associated with an entity matching an entity referenced by one or more of the n-grams of the query. As an example and not by way of limitation, an image object may depict the skyline of downtown New York City and may be associated with the entity New York City. Although this disclosure describes identifying image objects matching at least a portion of a query in a particular manner, this disclosure contemplates identifying image objects matching at least a portion of a query in any suitable manner.

In particular embodiments, the social-networking system 160 may access, for each of the identified image objects, an image embedding representing the image object. Each image embedding may correspond to a point in an m-dimensional embedding space. In particular embodiments, the social-networking system 160 may generate, for each of the identified image objects, the image embedding representing the image object. In particular embodiments, at least one of the image embeddings may be generated prior to receiving the query. In particular embodiments, the image embedding representing an image object may be generated based on one or more features of the image object. The social-networking system 160 may access a function [symbol] to map the image objects to corresponding image embeddings by feature extraction. As an example and not by way of limitation, the social-networking system 160 may generate an image embedding representing an image object based on one or more objects depicted in an image object, one or more concepts associated with the image object, any other suitable information, or any combination thereof. In connection with object recognition, determining concepts associated with an image, determining, and generating image embeddings, particular embodiments may utilize one or more systems, components, elements, functions, methods, operations, or steps disclosed in U.S. patent application Ser. No. 15/395,328, filed 30 Dec. 2016, U.S. patent application Ser. No. 15/395,564, filed 30 Dec. 2016, and U.S. patent application Ser. No. 15/395,512, filed 30 Dec. 2016, which are incorporated by reference. Although this disclosure describes accessing an image embedding and generating an image embedding in a particular manner, this disclosure contemplates accessing an image embedding and generating an image embedding in any suitable manner.

In particular embodiments, an image embedding representing an image object may be generated by a deep residual network. A deep neural network may refer to an ANN with at least two hidden layers. A deep residual network may be a deep neural network that may be a feedforward ANN comprising hidden layers organized into residual blocks. The input into each residual block after the first residual block may be a function of the output of the previous residual block and the input of the previous residual block. Although may describe a particular ANN, this disclosure contemplates any suitable ANN.

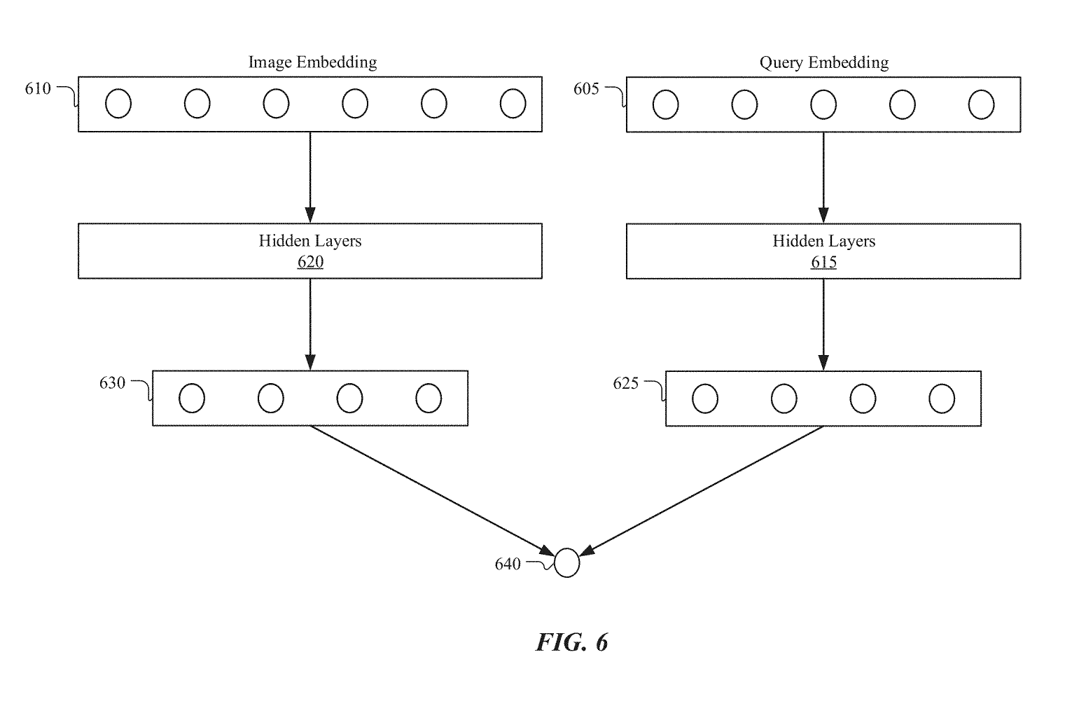

FIG. 6 illustrates an example joint embedding. In particular embodiments, the social-networking system 160 may transform, using a relevance model, the query embedding and each of the image embeddings into a joint p-dimensional embedding space. Each of the transformed embeddings may correspond to a point in the joint p-dimensional embedding space. As an example and not by way of limitation, a relevance model may be a model trained by machine learning to transform a query embedding and an image embedding into a joint embedding space. The image embedding may be an input into input layer 610, which may connect to one or more hidden layers 620. The relevance model may generate a transformed image embedding 630. The query embedding may be an input into input layer 605 and one or more hidden layers 615. The relevance model may generate a transformed query embedding 625. In particular embodiments, hidden layers 620 may comprise a different number of hidden layers than hidden layers 615. In particular embodiments, the relevance model may generate an output 640 based on the transformed query embedding 625 and the transformed image embedding 630. As an example and not by way of limitation, the output 640 may be a binary signal that indicates either a match or a non-match between the query and the image object. In particular embodiments, the relevance model may comprise a neural network trained by machine learning to transform query embeddings and image embeddings to a joint embedding space. In particular embodiments, the model used to generate a transformed query embedding and the model used to generate a transformed image embedding may be jointly trained using one or more parameters of the respective embedding layers. Although this disclosure describes transforming a query embedding and an image embedding into a joint embedding space in a particular manner, this disclosure contemplates transforming a query embedding and an image embedding into a joint embedding space in any suitable manner. Moreover, although this disclosure describes a particular relevance model, this disclosure contemplates any suitable relevance model.

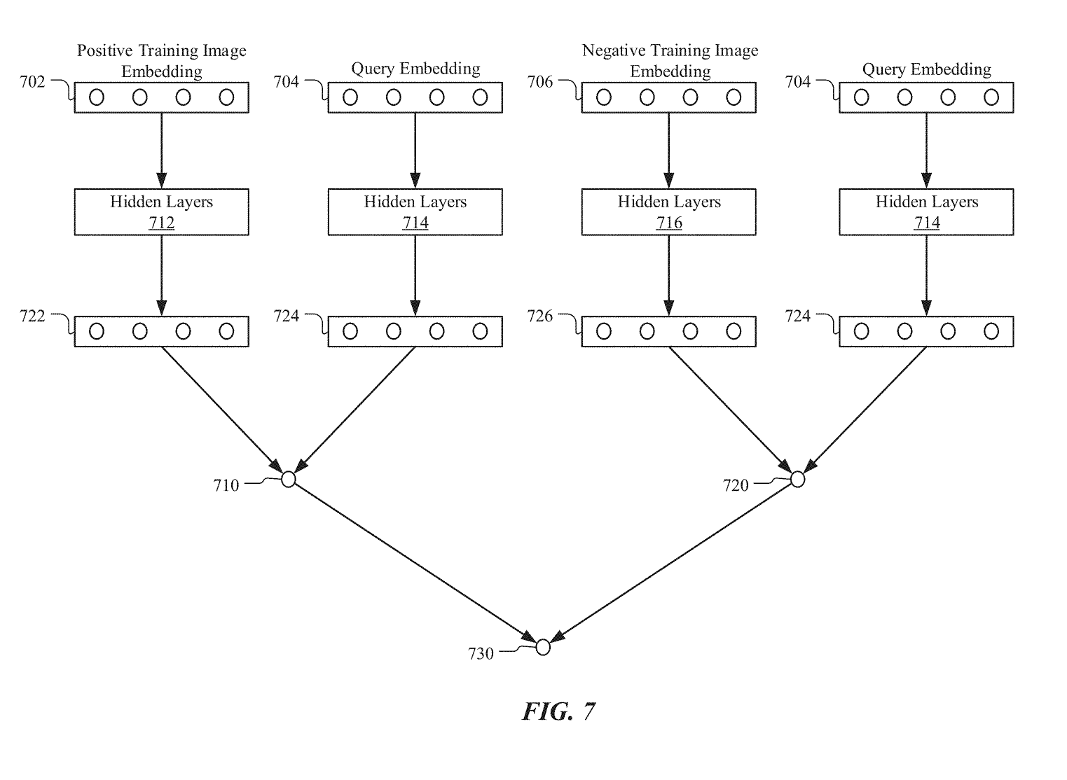

FIG. 7 illustrates an example of training an example relevance model. In particular embodiments, the relevance model may be trained based on training queries and training image objects. In particular embodiments, the social-networking system 160 may access a plurality of training queries. Each training query may comprise one or more n-grams. In particular embodiments, the social-networking system 160 may generate a plurality of training query embeddings representing the plurality of training queries, respectively. Each training query embedding may correspond to a point in the n-dimensional embedding space. In particular embodiments, the social-networking system 160 may generate a training image embedding representing a plurality of training image objects, respectively. Each training image embedding may correspond to a point in the m-dimensional embedding space. In particular embodiments, information may be associated with each of the training image embeddings indicating a relevance of the training image object to one or more of the training queries. In particular embodiments, the information associated with each of the training image embeddings indicating a relevance of the training image object to one or more of the training queries may comprise a binary signal (e.g., match or non-match, relevant or non-relevant, etc.). As an example and not by way of limitation, a query embedding may be input into input layer 704 and a machine learning model comprising hidden layers 714 may generate transformed query embedding 724. A positive training image embedding may be input into input layer 702 and a machine learning model comprising hidden layers 712 may generate transformed image embedding 722. A positive training image may be an image object that is relevant to the query. A negative training image embedding may be input into input layer 706 and a machine learning model comprising hidden layers 716 may generate transformed image embedding 726 representing the negative training image. A negative training image may be an image object that is not relevant to the query. In particular embodiments, the social-networking system 160 may train the relevance model to transform query embeddings and image embeddings to the joint p-dimensional embedding space using the plurality of training query embeddings and the plurality of training image embeddings. In particular embodiments, the relevance model may be trained by minimizing a ranking loss function. As an example and not by way of limitation, for a query and a positive training image, a relevance model may generate a binary output 710. For a query and a negative training image, the relevance model may generate a binary output 720. The output 710 and output 720 may be used to calculate a ranking loss 730. The relevance model may be trained by minimizing the ranking loss 730. Although this disclosure describes training a relevance model in a particular manner, this disclosure contemplates training a relevance model in any suitable manner.

In particular embodiments, the social-networking system 160 may calculate, for each identified image object, a relevance-score based on a similarity metric between the transformed query embedding and the transformed image embedding representing the identified image object. The similarity metric may be a cosine similarity, a Euclidian distance, or any other suitable similarity metric. As an example and not by way of limitation, the social-networking system 160 may calculate a relevance-score of an image object with respect to a query based at least in part on the cosine similarity between the query embedding and the image embedding representing the image object. In particular embodiments, the relevance-score of an identified image object may be calculated based on one or more attributes of the user. As an example and not by way of limitation, a user profile associated with the user may indicate that the user likes cats, and image objects associated with images of cats may be ranked higher than other image object or ranked higher than it would for users who do not like cats. In particular embodiments, the social-networking system 160 may calculate a relevance-score of an image object with respect to a query based at least in part on a concept associated with the query and a concept associated with the image object. As an example and not by way of limitation, for a query associated with the concept “dog” (e.g., the query “cute puppy pictures”), image objects associated with the concept “dog” may be ranked higher than image objects associated with the concept “animal”, and image objects associated with the concept “animal” may be ranked higher than image objects not associated with either the concept “dog” or the concept “animal”. Although this disclosure describes calculating a relevance-score in a particular manner, this disclosure contemplates calculating a relevance-score in any suitable manner.

In particular embodiments, the social-networking system 160 may generate one or more search results based on the calculated relevance-scores. Each search result may correspond to one of the image objects. As an example and not by way of limitation, the social-networking system 160 may generate search results corresponding to image objects with at least a threshold relevance-score. As another example and not by way of limitation, the social-networking system 160 may rank an identified image object based on a comparison of the query embedding and the image embedding representing the image object, and further based on a comparison of a concept associated with the query and a concept associated with the image object. In particular embodiments, the social-networking system 160 may generate search results corresponding image objects with at least a threshold relevance-score. In particular embodiments, the social-networking system 160 may generate a particular number search results corresponding to the image objects with the top relevance-scores. Although this disclosure describes generating search results in a particular manner, this disclosure contemplates generating search results in any suitable manner.

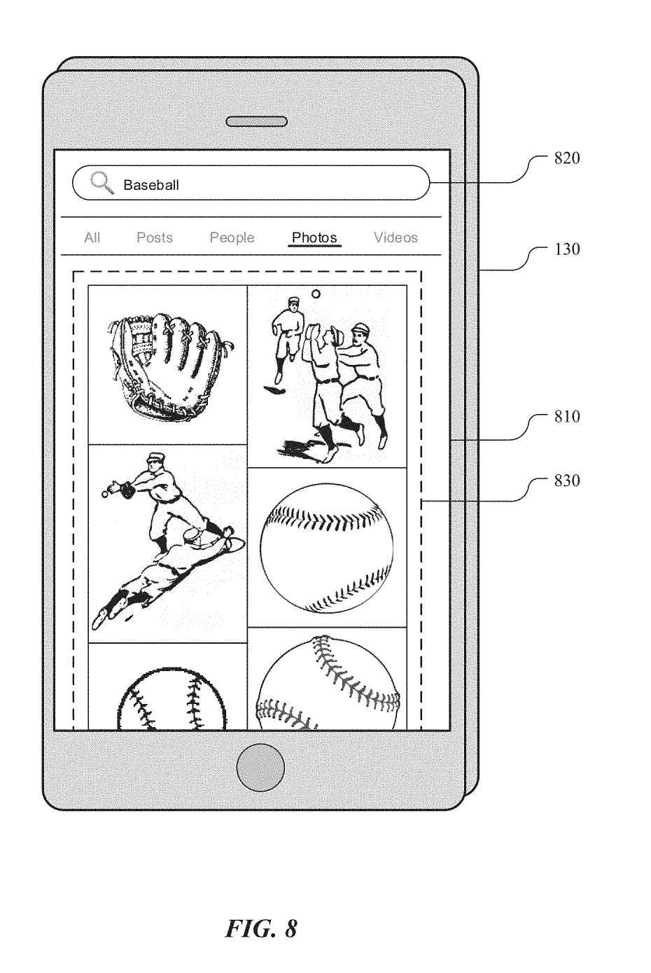

FIG. 8 illustrates an example search results interface 810. In particular embodiments, the social-networking system 160 may send, to the client system 130 of the user in response to the query, instructions for presenting a search-results interface to the user. The search-results interface may comprise one or more search results referencing one or more of the identified image objects, respectively. In particular embodiments, the search results may be presented in ranked order based on the respective relevance-scores of their corresponding identified image objects. As an example and not by way of limitation, a user may have input the query “baseball” into search bar 820. The query input into search bar 820 may be sent to the social-networking system 160. The social-networking system 160 may generate an embedding of the query based on the n-gram “baseball” and the concept “sports”, which is identified as a concept associated with the query. The social-networking system 160 may identify image objects matching the query and access an embedding associated with each identified image object. The social-networking system 160 may translate the query embedding and the image embeddings into a joint embedding space using a relevance model. The social-networking system 160 may calculate a relevance-score for each of the identified image objects based on the translated image embedding of the image object and the translated query embedding and based on a comparison the concept associated with the query to a concept associated with the identified image object. The social-networking system 160 may generate the search results 830 based on the calculated relevance-scores by generating a search result referencing a respective top-ranking image object (e.g., the identified image objects with a least a threshold relevance-score). The image objects referenced by the search results 830 may comprise relevant image objects responsive to the query “baseball”, such as images of baseballs, images of baseball players, and images of baseball equipment (e.g., baseball gloves, baseball bats, etc.), and other such image objects. In response to receiving the query, the social-networking system 160 may send to the client system 130 instructions for presenting the search-results interface 810. The search-results interface 810 may comprise search results 830. The search-results interface 810 may display the search results 830 in ranked order (e.g., the search results corresponding to image objects with higher relevance-scores may appear earlier in the list). Although this disclosure describes sending instructions for presenting a search-results interface in a particular manner, this disclosure contemplates sending instructions for presenting a search-results interface in any suitable manner.

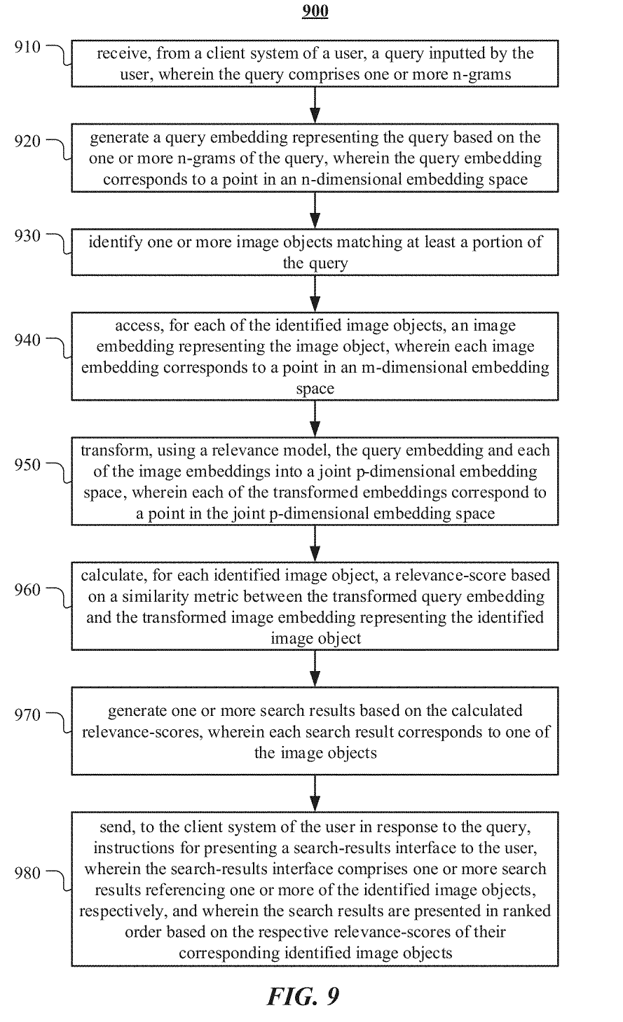

FIG. 9 illustrates an example method 900 for searching for image objects. The method may begin at step 910, where the social-networking system 160 may receive, from a client system of a user, a query inputted by the user, wherein the query comprises one or more n-grams. At step 920, the social-networking system 160 may generate a query embedding representing the query based on the one or more n-grams of the query, wherein the query embedding corresponds to a point in an n-dimensional embedding space. At step 930, the social-networking system 160 may identify one or more image objects matching at least a portion of the query. At step 940, the social-networking system 160 may access, for each of the identified image objects, an image embedding representing the image object, wherein each image embedding corresponds to a point in an m-dimensional embedding space. At step 950, the social-networking system 160 may transform, using a relevance model, the query embedding and each of the image embeddings into a joint p-dimensional embedding space, wherein each of the transformed embeddings correspond to a point in the joint p-dimensional embedding space. At step 960, the social-networking system 160 may calculate, for each identified image object, a relevance-score based on a similarity metric between the transformed query embedding and the transformed image embedding representing the identified image object. At step 970, the social-networking system 160 may generate one or more search results based on the calculated relevance-scores, wherein each search result corresponds to one of the image objects. At step 980, the social-networking system 160 may send, to the client system of the user in response to the query, instructions for presenting a search-results interface to the user, wherein the search-results interface comprises one or more search results referencing one or more of the identified image objects, respectively, and wherein the search results are presented in ranked order based on the respective relevance-scores of their corresponding identified image objects. Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for searching for image objects including the particular steps of the method of FIG. 9, this disclosure contemplates any suitable method for searching for image objects including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

### Systems and Methods

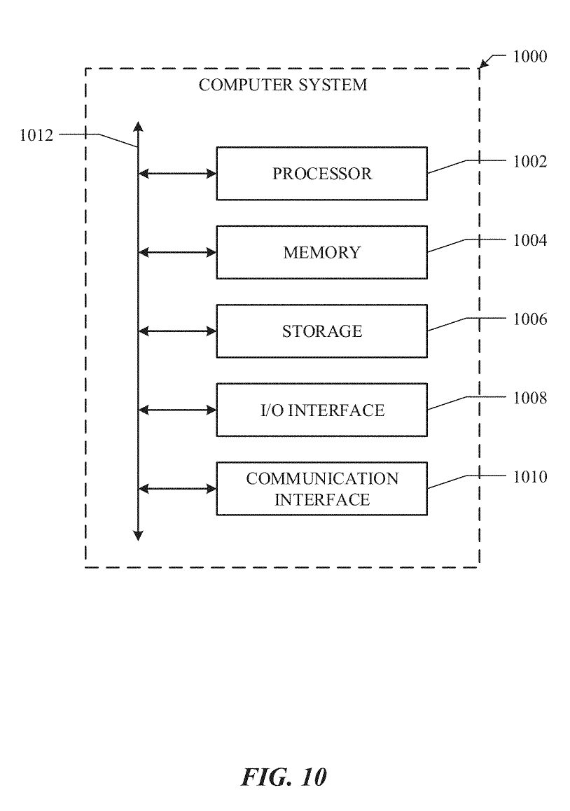

FIG. 10 illustrates an example computer system 1000. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein. As an example and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### MISCELLANEOUS

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
receiving, from a client system of a user, a query inputted by the user, wherein the query comprises one or more n-grams;
generating a query embedding representing the query based on the one or more n-grams of the query, wherein the query embedding corresponds to a point in an n-dimensional embedding space;
identifying one or more image objects matching at least a portion of the query;
accessing, for each of the identified image objects, an image embedding representing the image object, wherein each image embedding corresponds to a point in an m-dimensional embedding space;
transforming, using a relevance model, the query embedding and each of the image embeddings into a joint p-dimensional embedding space, wherein each of the transformed embeddings correspond to a point in the joint p-dimensional embedding space;
calculating, for each identified image object, a relevance-score based on a similarity metric between the transformed query embedding and the transformed image embedding representing the identified image object;
generating one or more search results based on the calculated relevance-scores, wherein each search result corresponds to one of the image objects; and
sending, to the client system of the user in response to the query, instructions for presenting a search-results interface to the user, wherein the search-results interface comprises one or more search results referencing one or more of the identified image objects, respectively, and wherein the search results are presented in ranked order based on the respective relevance-scores of their corresponding identified image objects.

2. The method of claim 1, wherein the relevance model comprises a neural network trained by machine learning to transform query embeddings and image embeddings to a joint embedding space.

3. The method of claim 1, wherein the relevance model was trained by:
accessing a plurality of training queries, wherein each training query comprises one or more n-grams;
generating a plurality of training query embeddings representing the plurality of training queries, respectively, wherein each training query embedding corresponds to a point in the n-dimensional embedding space;
generating a training image embedding representing a plurality of training image objects, respectively, wherein each training image embedding corresponds to a point in the m-dimensional embedding space, and wherein information is associated with each of the training image embeddings indicating a relevance of the training image object to one or more of the training queries; and
training the relevance model to transform query embeddings and image embeddings to the joint p-dimensional embedding space using the plurality of training query embeddings and the plurality of training image embeddings.

4. The method of claim 3, wherein the information associated with each of the training image embeddings indicating a relevance of the training image object to one or more of the training queries comprises a binary signal.

5. The method of claim 3, wherein the relevance model was trained by minimizing a ranking loss function.

6. The method of claim 1, further comprising generating, for each of the identified image objects, the image embedding representing the image object.

7. The method of claim 1, wherein at least one of the image embeddings was generated prior to receiving the query.

8. The method of claim 1, wherein, for each of the identified image objects, the image embedding representing the image object was generated based one or more features of the image object.

9. The method of claim 1, wherein, for each of the identified image objects, the image embedding representing the image object was generated by a deep residual network.

10. The method of claim 1, wherein the query embedding representing the query is generated in real-time and responsive to receiving the query from the client system of the user.

11. The method of claim 1, wherein the query embedding is a reconstructed embedding of the query generated based on one or more term embeddings associated with the one or more n-grams of the query, respectively, and wherein each of the one or more term embeddings correspond to a point in the n-dimensional embedding space.

12. The method of claim 1, wherein the relevance-score of each identified image object is calculated further based on one or more attributes of the user.

13. The method of claim 1, wherein the similarity metric comprises a cosine similarity.

14. The method of claim 1, wherein identifying one or more image objects matching at least a portion of the query comprises identifying one or more image objects associated with a concept matching a concept of the query.

15. The method of claim 14, wherein one of the concepts associated with one of the image objects comprises a scene, a physical object, an animal, a plant, a place, an article of clothing, or a location.

16. The method of claim 1, wherein identifying one or more image objects matching at least a portion of the query comprises identifying one or more image objects associated with an entity matching an entity referenced by one or more of the n-grams of the query.

17. One or more computer-readable non-transitory storage media embodying software that is operable when executed to:
receive, from a client system of a user, a query inputted by the user, wherein the query comprises one or more n-grams;
generate a query embedding representing the query based on the one or more n-grams of the query, wherein the query embedding corresponds to a point in an n-dimensional embedding space;
identify one or more image objects matching at least a portion of the query;
access, for each of the identified image objects, an image embedding representing the image object, wherein each image embedding corresponds to a point in an m-dimensional embedding space;
transform, using a relevance model, the query embedding and each of the image embeddings into a joint p-dimensional embedding space, wherein each of the transformed embeddings correspond to a point in the joint p-dimensional embedding space;
calculate, for each identified image object, a relevance-score based on a similarity metric between the transformed query embedding and the transformed image embedding representing the identified image object;
generate one or more search results based on the calculated relevance-scores, wherein each search result corresponds to one of the image objects; and
send, to the client system of the user in response to the query, instructions for presenting a search-results interface to the user, wherein the search-results interface comprises one or more search results referencing one or more of the identified image objects, respectively, and wherein the search results are presented in ranked order based on the respective relevance-scores of their corresponding identified image objects.

18. The media of claim 17, wherein the relevance model comprises a neural network trained by machine learning to transform query embeddings and image embeddings to a joint embedding space.

19. The media of claim 17, wherein the relevance model was trained by:
accessing a plurality of training queries, wherein each training query comprises one or more n-grams;
generating a plurality of training query embeddings representing the plurality of training queries, respectively, wherein each training query embedding corresponds to a point in the n-dimensional embedding space;
generating a training image embedding representing a plurality of training image objects, respectively, wherein each training image embedding corresponds to a point in the m-dimensional embedding space, and wherein information is associated with each of the training image embeddings indicating a relevance of the training image object to one or more of the training queries; and
training the relevance model to transform query embeddings and image embeddings to the joint p-dimensional embedding space using the plurality of training query embeddings and the plurality of training image embeddings.

20. A system comprising: one or more processors; and a non-transitory memory coupled to the processors comprising instructions executable by the processors, the processors operable when executing the instructions to:
receive, from a client system of a user, a query inputted by the user, wherein the query comprises one or more n-grams;
generate a query embedding representing the query based on the one or more n-grams of the query, wherein the query embedding corresponds to a point in an n-dimensional embedding space;
identify one or more image objects matching at least a portion of the query;
access, for each of the identified image objects, an image embedding representing the image object, wherein each image embedding corresponds to a point in an m-dimensional embedding space;
transform, using a relevance model, the query embedding and each of the image embeddings into a joint p-dimensional embedding space, wherein each of the transformed embeddings correspond to a point in the joint p-dimensional embedding space;
calculate, for each identified image object, a relevance-score based on a similarity metric between the transformed query embedding and the transformed image embedding representing the identified image object;
generate one or more search results based on the calculated relevance-scores, wherein each search result corresponds to one of the image objects; and
send, to the client system of the user in response to the query, instructions for presenting a search-results interface to the user, wherein the search-results interface comprises one or more search results referencing one or more of the identified image objects, respectively, and wherein the search results are presented in ranked order based on the respective relevance-scores of their corresponding identified image objects.
